(19) United States
(12) Patent Application Publication
(10) Pub. No.: US 2007/0037726 A1
(43) Pub. Date: Feb. 15, 2007

(54) Solid detergent comprising A C1-C3 alkyl carbonate salt

(76) Inventors: Alan Thomas Brooker, Newcastle-upon-Tyne (GB); Adam Thomas Yates, (US); Nigel Patrick Somerville Roberts, Newcastle-upon-Tyne (GB); Nicholas Andrew Barnes, Stockport (GB); Stephen Martin Godfrey, Cheshire (GB); Wasif Hussain, Manchester (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/201,621

(22) Filed: Aug. 11, 2005

(51) Int. Cl. C11D 3/37

(52) U.S. Cl. 510/476

(57) ABSTRACT

The present invention relates to a solid detergent composition comprising a C₁-C₃ alkyl carbonate salt.

### TECHNICAL FIELD

The present invention relates to a solid detergent composition comprising a C₁-C₃ alkyl carbonate salt.

### BACKGROUND TO THE INVENTION

Solid detergent compositions comprise detersive surfactants to provide cleaning. However, detersive surfactants have a tendency to gel upon contact with water, which impairs the dispensing and dissolution of the solid detergent composition. Detergent manufacturers have attempted to overcome this problem by incorporating effervescence systems and hydrotropes in the composition to improve the dispensing and dissolution of the composition. Another means of improving the dispensing and dissolution profile of a solid detergent composition is to incorporate a solvent, such as a short alkyl chain alcohol, into the composition. However, these solvents tend to be liquid at ambient conditions, and their incorporation into a solid detergent composition is difficult. Methods of incorporating a liquid solvent into a solid detergent composition, such as absorption/adsorption onto solid carriers, restrict the detergent formulator. For example, there is a limit to the level of liquid solvent that can be incorporated into a solid detergent composition. If too much liquid solvent is incorporated into the solid detergent composition, then the composition will have a poor flowability profile. However, if not enough solvent is incorporated into the solid detergent composition, then the dispensing and dissolution profiles of the composition will not be improved. There remains a need to incorporate enough solvent into a solid detergent composition to improve its dispensing and dissolution profiles whilst at the same time ensure that the composition still has a good flowability profile.

### SUMMARY OF THE INVENTION

The present invention provides a solid detergent composition comprising a C₁-C₃ alkyl carbonate salt.

### DETAILED DESCRIPTION OF THE INVENTION

C₁-C₃ Alkyl Carbonate Salt

The composition comprises a C₁-C₃ alkyl carbonate salt. A preferred C₁-C₃ alkyl carbonate salt is a methyl carbonate salt and/or an ethyl carbonate salt and/or a propyl carbonate salt and/or an iso-propyl carbonate salt. More preferably, the C₁-C₃ alkyl carbonate salt is a methyl carbonate salt. The salt can be an alkali and/or an alkaline earth metal salt of a C₁-C₃ alkyl carbonate. Preferably a sodium and/or potassium and/or magnesium salt of a C₁-C₃ alkyl carbonate. More preferably a sodium salt of a C₁-C₃ alkyl carbonate. Most preferably, the C₁-C₃ alkyl carbonate salt is sodium methyl carbonate.

The C₁-C₃ alkyl carbonate salt liberates carbon dioxide and a C₁-C₃ alkyl alcohol upon contact with water. This provides effervescence and the release of a solvent alcohol into the wash liquor, which in turn improves the dispensing and dissolution profile of the solid composition. The C₁-C₃ alkyl carbonate salt can be used to improve the dispensing performance, the dissolution performance, the cleaning performance and the aesthetics of the foam profile of the composition. This is especially preferred when the composition is a laundry detergent composition. The C₁-C₃ alkyl carbonate salt also provides effervescence, for example during a laundering process.

Preferably, the C₁-C₃ alkyl carbonate salt is in particulate solid form, preferably in free-flowing particulate form. By free-flowing particulate form it is meant that the C₁-C₃ alkyl carbonate is in the form of separate discrete particles. Preferably, the C₁-C₃ alkyl carbonate salt is in particulate form having a particle size distribution such that the weight average particle size is from 50 micrometers to 2,000 micrometers, or preferably from 100 micrometers to 1,000 micrometers, or preferably from 100 micrometers to 800 micrometers, or preferably from 400 to 700 micrometers. Typically, no more than 10 wt % of the C₁-C₃ alkyl carbonate salt has a particle size of greater than 1150 micrometers and, typically, no more than 10 wt % of the C₁-C₃ alkyl carbonate salt has a particle size of less than 50 micrometers. If the C₁-C₃ alkyl carbonate salt has an average particle size of greater than 1,500 micrometers, then it may be preferred for the C₁-C₃ alkyl carbonate salt to be in the form of an extrudate.

The composition preferably comprises from 0.01 wt % to 50 wt %, or preferably from 0.1 wt % to 20wt %, more preferably from 1 wt % to 10 wt % C₁-C₃ alkyl carbonate salt.

The C₁-C₃ alkyl carbonate salt can be in form of an agglomerate, an extrudate, a spray-dried powder, a bead or a combination thereof. The C₁-C₃ alkyl carbonate salt may be in the form of a co-particulate admix with a detergent adjunct component. By co-particulate admix it is meant that the C₁-C₃ alkyl carbonate salt and detergent adjunct component are mixed together, so that they are present in the composition in the same particle. Preferably, the co-particulate admix is in the form of: an extrudate such as a bead, a noodle and/or a needle; a spray-dried powder; an agglomerate; a flake; or a mixture thereof. Preferably, the co-particulate admix is in the form of an agglomerate.

It may be preferred for the detergent adjunct component to comprise an acid source, such as sulphamic acid and/or citric acid. The presence of an acid source in the same particle as the C₁-C₃ alkyl carbonate salt, improves the hydrolysis of the C₁-C₃ alkyl carbonate salt upon contact with water and increases the rate of release of the C₁-C₃ alcohol into the wash liquor. It may be preferred for the adjunct detergent component to comprise a bleach activator, such as tetraacetyl ethylene diamine. The C₁-C₃ alkyl alcohol which is liberated when the C₁-C₃ alkyl carbonate salt is contacted to water, improves the dissolution and the rate of perhydrolysis of the bleach activator. It may be preferred for the adjunct detergent component to comprise a detersive surfactant, such as a non-ionic detersive surfactant. This provides a good sudsing profile. It may be preferred for the adjunct detergent component to comprise an acid source, such as sulphamic acid and/or citric acid, and a bleach activator, such as tetraacetyl ethylene diamine.

The adjunct component may also be a detersive surfactant such as an alkyl sulphate or an alkyl polyglucoside. Preferred alkyl sulphates are described in more detail below. A preferred alkyl polyglucoside is supplied by Seppici under the tradename Montanov S™.

Synthesis of the C₁-C₃ Alkyl Carbonate Salt.

The C₁-C₃ alkyl carbonate salt is typically obtained by a process comprising the steps of: (a) reacting an alkali and/or alkaline earth metal source, for example the metal or a metal hydride or an organometallic compound such as a C₁₋₄ alkyl metal compound, with a C₁₋₃ alcohol, to form a metal alkoxide; and (b) reacting the metal alkoxide with carbon dioxide to form a C₁-C₃ alkyl carbonate salt. There is no need to separate the metal alkoxide product of step (a) from any excess C₁₋₃ alcohol substrate, as the presence of an alcohol in step (b) is especially preferred. It is especially preferred for the metal alkoxide to be dissolved in a liquid medium, such as an alcohol, during step (b) when it is reacted with carbon dioxide. Any excess C₁₋₃ alcohol substrate from step (a) that may be carried over into step (b) can act as the liquid medium of step (b). This is especially preferred as the metal alkoxide product of step (a) is typically dissolved in any excess C₁₋₃ alcohol and reuse of the C₁₋₃ alcohol substrate as the reaction medium of step (b) negates the need for isolation and re-dissolution of the metal alkoxide. The carbon dioxide is preferably in gaseous form during step (b). The C₁-C₃ alkyl carbonate salt is typically formed as a solid precipitate. It is typically separated from the liquid reaction medium of step (b) by any suitable means: including decanting, filtering, distillation of the reaction medium, centrifugation, and/or evaporation of the reaction medium. Steps (a) and (b) may be carried out in the same reaction vessel or may be carried out in different reaction vessels. To make the preferred sodium methyl carbonate, sodium metal in solid form is reacted with methanol in liquid form to form sodium methoxide that is dissolved in excess methanol. The sodium methoxide is subsequently reacted with carbon dioxide in gaseous form, to form sodium methyl carbonate in solid form. The sodium methyl carbonate is separated from the reaction medium by filtration.

Detergent Adjunct Component

The composition typically comprises a detergent adjunct component. The detergent adjunct component may be present in the composition either in the same particle as the C₁-C₃ alkyl carbonate salt, or in separate particles from the C₁-C₃ alkyl carbonate salt. The detergent adjunct component typically comprises components selected from the group consisting of anionic detersive surfactants, cationic detersive surfactants, non-ionic detersive surfactants, zwitterionic detersive surfactants, builders, polymeric co-builders such as polymeric polycarboxylates, bleach, chelants, enzymes, anti-redeposition polymers, soil-release polymers, polymeric soil-dispersing and/or soil-suspending agents, dye-transfer inhibitors, fabric-integrity agents, brighteners, suds suppressors, fabric-softeners, flocculants, cationic fabric-softening components, perfumes and combinations thereof.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₈ alkylbenzene sulphonates, preferably linear C₁₀₋₁₃ alkylbenzene sulphonates; and mixtures thereof. Highly preferred are commercially available C₁₀₋₁₃ linear alkylbenzene sulphonates. Highly preferred are linear C₁₀₋₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

Preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono C₁₀ alkyl mono-hydroxyethyl di-methyl quaternary ammonium chloride.

Preferred non-ionic detersive surfactants are C₈₋₁₈ alkyl alkoxylated alcohols, typically having a molar average alkoxylation degree of from 1 to 20, preferably from 1 to 10. Preferred are C₈₋₁₈ alkyl ethoxylated alcohols having a molar average ethoxylation degree of from 3 to 7.

The composition may preferably comprise an anionic detersive surfactant. The composition may also preferably comprise a non-ionic detersive surfactant and a cationic detersive surfactant.

Preferred builders are selected from the group consisting of: zeolite such as zeolite A, zeolite P, zeolite MAP and zeolite X; phosphate such as sodium tripolyphosphate; sodium carbonate; citric acid and/or water soluble salts thereof such as sodium citrate; sulphamic acid and/or water-soluble salts thereof such as sodium sulphamate; polymeric polycarboxylates such as co-polymers of acrylic acid and maleic acid, or polyacrylate; and any mixture thereof.

However, it may be preferred for the composition to comprise low levels of builders, especially water-insoluble builders such as zeolite. This is especially preferred if it is desirable for the composition to be very highly soluble. In addition, the composition may comprise low levels of builders such as phosphate builders (e.g. sodium tripolyphosphate): for example, due to the phosphate regulations of a number of countries. It may be preferred for the composition to comprise less than 5 wt % zeolite builder and less than 5 wt % phosphate builder. It may be preferred for the composition to be essentially free from zeolite builder and/or to be essentially free from phosphate builder. By essentially free from zeolite builder and/or phosphate builder it is meant that the composition comprises no deliberately added zeolite builder and/or phosphate builder.

The composition may comprise sulphamic acid and/or water-soluble salts thereof. The water-soluble salts of sulphamic acid can be alkali-metal or an alkaline-earth-metal salts of sulphamate. Other examples of water-soluble salts of sulphamic acid include ammonium sulphamate, zinc sulphamate and lead sulphamate. A preferred water-soluble salt of sulphamic acid is sodium sulphamate. Preferably, the composition comprises sulphamic acid.

It may be preferred for the composition to comprise a non-alkyl substituted carbonate salt, typically from 1 wt % to 50 wt %, or from 5 wt % to 25 wt % or from 10 wt % to 20 wt % non-alkyl substituted carbonate salt. A preferred non-alkyl substituted carbonate salt is sodium carbonate and/or sodium bicarbonate. A highly preferred non-alkyl substituted carbonate salt is sodium carbonate.

The composition may comprise at least 10 wt % sulphate salt. The sulphate salt is highly preferably water-soluble. A preferred sulphate salt is an alkali-metal salt of sulphate, very highly preferred is sodium sulphate. High levels of sulphate salt can improve the greasy stain removal cleaning performance of the composition. The composition preferably comprises very high levels of sulphate salt; the composition typically comprises at least 15 wt % sulphate salt, or even 20 wt % sulphate salt, or even 25 wt % sulphate salt and sometimes even at least 30 wt % sulphate salt.

Other adjunct components include: bleach such as percarbonate and/or perborate; bleach such as percarbonate and/or perborate, preferably in combination with a bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-Pthaloylamino peroxycaproic acid, nonylamido peroxyadipic acid or dibenzoyl peroxide; chelants such as diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid); enzymes such as amylases, carbohydrases, cellulases, laccases, lipases, oxidases, peroxidases, proteases, pectate lyase, and mannanase; suds suppressing systems such as silicone based suds suppressors; brighteners; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; dispersants such as polycarboxylates, alkoxylated polyamines and ethoxylated ethyleneimine polymers; and anti-redeposition components such as carboxymethyl cellulose and polyesters.

Composition

The composition can be in any solid form, such as in the form of free-flowing particles or in the form of a tablet. By “free-flowing particles” it is meant that the composition is in the form of separate discrete particles. Preferably, the composition is in the form of free-flowing particles such as agglomerates, extrudates, spray-dried particles, noodles, needles, flakes and mixtures thereof. It may be preferred that the composition is not in tablet form. The composition in free-flowing particulate form typically has a bulk density of from 450 g/l to 1,000 g/l, preferred low bulk density compositions have a bulk density of from 550 g/l to 650 g/l and preferred high bulk density compositions have a bulk density of from 750 g/l to 900 g/l. The composition may be a laundry composition, dishwashing composition or a hard surface cleaning composition. Preferably, the composition is a laundry composition. During the laundering process, the composition is typically contacted with water to give a wash liquor having a pH of from above 7 to 11, preferably from 8 to 10.5.

The composition can be obtained by any suitable process, such as spray-drying, agglomeration, extrudation and/or compaction. The process may also include the process steps of, marumerising, spheronising, fluid bed drying, fluid bed agglomeration, enclosing the composition in a water-soluble film and combinations thereof. Preferably, the process comprises the step of contacting the C₁-C₃ alkyl carbonate salt with a bleach activator and/or an acid source.

### EXAMPLES

### Example 1

### Method of Synthesis of Sodium Methyl Carbonate

A 20-litre flange flask is flame-dried and fitted with an overhead stirrer (steel shaft with PTFE crescent-shaped stirrer blade), an inlet and outlet for dry nitrogen, and two glass tubes for the introduction of CO₂ (placed on opposite sides of the flask). The system is purged with dry nitrogen for 15 minutes, whereupon 10 litres of approx. 30% sodium methoxide solution (approx. 55.5 moles of NaOMe) in methanol is poured in under a flow of nitrogen and the solution is stirred. The CO₂ bubbler tubes are adjusted so that the bottom of each tube is just below the surface of the solution when stirring. Carbon dioxide (CP grade) is introduced into the solution through the two tubes, and the flow rate adjusted so that steady bubbling is maintained for 36 hours during which time sodium methyl carbonate forms and precipitates out of solution.

After 36 hours the sodium methyl carbonate precipitate is filtered onto large no. 2 porosity sintered glass filter funnels, and washed with a total of 10 litres of methanol to ensure that any unreacted sodium methoxide is completely removed. The sodium methyl carbonate is washed with diethyl ether (total of 10 litres). The sodium methyl carbonate is dried in vacuo. The yield of sodium methyl carbonate is typically between 4.5 and 5.0 kg from each batch, performed using the quantities described above.

### Example 2

### Method of Making Particles Comprising Sodium Methyl Carbonate

150 g of tetraacetyl ethylene diamine (TAED) powder is melted by heating it in an oven at 150° C. for 2 hours, and then placing it in an aluminium beaker on a hotplate having a surface temperature in excess of 200° C. whilst vigorously stirring. 23 g of Neodol C₄₅E₅™ (supplied by Shell) non-ionic detersive surfactant is added to the melting TAED to form a hot mix. 10 g of sodium methyl carbonate powder is added to the hot mix. Once the subsequent foam has subsided, the hot mix is rapidly poured onto a powder mixture of 70 g sodium methyl carbonate, 80 g of sodium carbonate and 60 g of micronised (i.e. pre-ground) citric acid in a Kenwood FP570™ food mixer, and mixed at high speed for less than 30 seconds. The resultant product is sieved to remove any unwanted oversizec particles (e.g. particles having a diameter of larger than 1.4 mm) and unwanted fines (e.g. particles having a diameter of less than 350 micrometers). Particles comprising sodium methyl carbonate are obtained.

### Example 3

### Method of Making Particles Comprising Sodium Methyl Carbonate

100 g of tetraacetyl ethylene diamine (TAED) powder is melted by heating it in an oven at 150° C. for 2 hours, and then placing it in an aluminium beaker on a hotplate having a surface temperature in excess of 200° C. whilst vigorously stirring, to form a molten mixture. The molten mixture is rapidly poured onto a powder mixture of 40 g sodium methyl carbonate, 40 g of sodium carbonate and 40 g of sulphamic acid in a Kenwood FP570™ food mixer, and mixed at high speed for less than 30 seconds. The resultant product is sieved to remove any unwanted oversizec particles (e.g. particles having a diameter of larger than 1.4 mm) and unwanted fines (e.g. particles having a diameter of less than 350 micrometers). Particles comprising sodium methyl carbonate are obtained.

### Example 4

### Method of Making Particles Comprising Sodium Methyl Carbonate

220 g of alkyl polyglucoside (Montanov S by Seppici) powder is melted by heating it in an oven at 65° C. for 2 hours to form a molten mixture. The molten mixture is rapidly poured onto a powder mixture of 350 g sodium methyl carbonate, 700 g of sulphamic acid in a Kenwood FP570™ food mixer, and mixed at speed setting 2 for 1 minute. The resultant product is sieved to remove any unwanted oversizec particles (e.g. particles having a diameter of larger than 1.4 mm) and unwanted fines (e.g. particles having a diameter of less than 350 micrometers). Particles comprising sodium methyl carbonate are obtained.

### Example 5

### Method of Making Particles Comprising Sodium Methyl Carbonate

220 g of alkyl polyglucoside (Montanov S by Seppici) powder, 350 g sodium methyl carbonate, and 700 g of sulphamic acid are dosed into a Kenwood FP570™ food mixer and mixed at speed setting 2 for 3 minutes. The resultant mixture is placed in an oven at 50° C. for 1 hour. The mixture is then dosed into a Kenwood FP570™ food mixer and mixed at speed setting 2 for another 3 minutes. The resultant product is sieved to remove any unwanted oversizec particles (e.g. particles having a diameter of larger than 1.4 mm) and unwanted fines (e.g. particles having a diameter of less than 350 micrometers). Particles comprising sodium methyl carbonate are obtained.

### Examples 6-14

### Particulate Laundry Detergent Compositions Comprising Sodium Methyl Carbonate

The amount of ingredients given below is in wt %.

| | Example | | | | | | | | |
|---|---|---|---|---|---|---|---|---|---|
| composition | 6 | 7 | 8 | 9 | 10 | 11 | 12 | 13 | 14 |
| Spay-dried powder | | | | | | | | | |
| A compound having the following general structure: | 0.72 | | 0.72 | 0.72 | 0.72 | 0.72 | | | |
| bis((C₂H₅O)(C₂H₄O)n)(CH₃)—N⁺—CₓH₂ₓ—N⁺—(CH₃)- | | | | | | | | | |
| bis((C₂H₅O)(C₂H₄O)n), wherein n = from 20 to 30, and | | | | | | | | | |
| x = from 3 to 8, or sulphated or sulphonated variants thereof | | | | | | | | | |
| Diethylene triamine penta(methyl phosphonic) acid | | | | | | | 0.19 | 0.13 | 0.20 |
| Citric acid | | | | | | | 2.81 | | |
| Ethylenediamine disuccinic acid | 0.20 | | 0.20 | 0.20 | 0.20 | 0.20 | 0.09 | | |
| Brightener | 0.07 | | 0.07 | 0.07 | 0.07 | 0.07 | | 0.10 | 0.06 |
| Magnesium sulphate | 0.42 | | 0.42 | 0.42 | 0.42 | 0.42 | | | |
| Acrylate/maleate copolymer | 3.74 | 5.00 | 3.74 | 3.74 | 3.74 | 3.74 | | 2.40 | 0.62 |
| Soil release polymer | | | | | | | | | 0.62 |
| Linear alkyl benzene sulphonate | 6.90 | 18.00 | 6.90 | 6.90 | 6.90 | 6.90 | 10.22 | 9.47 | 9.96 |
| Sodium C₁₂₋₁₅ alkyl ethoxy sulphate having a molar | | 2.00 | | | | | | | |
| average degree of ethoxylation of 3 | | | | | | | | | |
| Tallow (C₁₆₋₁₈) alkyl ethoxylated alcohol having a | | | | | | | | 0.90 | |
| molar average degree of ethoxylation of 5 | | | | | | | | | |
| Tallow (C₁₆₋₁₈) alkyl ethoxylated alcohol having a | | 2.70 | | | | | | | |
| molar average degree of ethoxylation of 80 | | | | | | | | | |
| Hydroxyethane di(methylene phosphonic acid) | 0.19 | | 0.19 | 0.19 | 0.19 | 0.19 | 0.30 | 0.47 | 0.13 |
| Carboxyl methyl cellulose | | | | | | | 1.60 | 2.37 | 0.56 |
| Sodium carbonate | 2.50 | 18.00 | 2.50 | 2.50 | 2.50 | 10.93 | 20.02 | 11.63 | 7.27 |
| Sodium sulphate | 27.49 | 38.03 | 27.49 | 27.49 | 27.49 | 19.06 | | 12.55 | 6.89 |
| Sodium silicate 2.0R | | | | | | | 4.76 | 1.78 | 6.96 |
| Sodium toluene sulphonate | | 0.90 | | | | | | | |
| Caustic soda | | 0.12 | | | | | | | |
| Sodium citrate | | | | | | | | 2.83 | |
| Soap | 0.45 | | 0.45 | 0.45 | 0.45 | 0.45 | 1.03 | 0.50 | 1.35 |
| PEG 4000 | | | | | | | | 0.25 | |
| Zeolite MAP | | | | | | | | | 21.87 |
| Water | 0.43 | 5.40 | 0.43 | 0.43 | 0.43 | 0.43 | 0.43 | 3.71 | 2.59 |
| Miscellaneous | 0.24 | 0.73 | 0.24 | 0.24 | 0.24 | 0.24 | 1.11 | 2.82 | 1.52 |
| Total amount of spray-dried powder | 43.34 | 90.88 | 43.34 | 43.34 | 43.34 | 43.34 | 42.56 | 51.91 | 60.61 |
| AES surfactant agglomerate | | | | | | | | | |
| Sodium C₁₂₋₁₅ alkyl ethoxy sulphate having a molar | 4.76 | | 4.76 | 2.38 | 4.76 | 4.76 | 0.48 | 2.38 | |
| average degree of ethoxylation of 3 | | | | | | | | | |
| Sodium carbonate | 10.85 | | 10.85 | 5.43 | 10.85 | 14.28 | 1.09 | 5.43 | |
| Sodium sulphate | 3.43 | | 3.43 | 1.72 | 3.43 | 0.00 | 0.34 | 1.72 | |
| Total amount of AES surfactant agglomerate | 19.04 | | 19.04 | 9.52 | 19.04 | 19.04 | 1.90 | 9.52 | |
| Cationic surfactant agglomerate | | | | | | | | | |
| Mono-C₁₂₋₁₄ alkyl mono-hydroxyethyl di-methyl | 0.94 | | 0.94 | 0.94 | 0.94 | 0.94 | | | |
| quaternary ammonium chloride | | | | | | | | | |
| Sodium carbonate | 2.67 | 4.00 | 2.67 | 2.67 | 2.67 | 5.33 | | | |
| Sodium sulphate | 2.67 | | 2.67 | 2.67 | 2.67 | 0.00 | | | |
| Total amount of cationic surfactant agglomerate | 6.27 | | 6.27 | 6.27 | 6.27 | 6.27 | | | |
| Non-ionic surfactant particle | | | | | | | | | |
| C₁₄₋₁₅ alkyl ethoxylated alcohol having a molar average | | | | 2.00 | | | | | |
| degree of ethoxylation of 7 | | | | | | | | | |
| Sodium sulphate | | | | 8.20 | | | | | |
| Total amount of non-ionic surfactant particle | | | | 10.20 | | | | | |
| Dry added/Spray on components | | | | | | | | | |
| Sodium methyl carbonate particle of examples 2, 3, 4 or 5 | 1.0 | 2.5 | 5.0 | 0.5 | 3.0 | 2.0 | 1.5 | 4.0 | 3.5 |
| C₁₂₋₁₅ alkyl ethoxylated alcohol having a molar average | | | | | | | | | 3.36 |
| degree of ethoxylation of 3 (AE3) | | | | | | | | | |
| Sodium carbonate | | | | | | | | | 5.32 |
| 91.6 wt % active linear alkyl benzene sulphonate flake supplied | 0.22 | | 0.22 | 0.22 | 0.22 | 0.22 | | | |
| by Stepan under the tradename Nacconol 90G ® | | | | | | | | | |
| Polyvinylpyrrolidone | | 0.20 | | | | | | | |
| Citric acid | 4.00 | 0.50 | 5.00 | 5.00 | | 3.00 | 0.93 | | 3.08 |
| Sulphamic acid | | | | | 2.00 | | | | |
| Sodium percarbonate (having from 12% to 15% active AvOx) | 14.70 | | 9.70 | 14.20 | 14.70 | 18.02 | 14.21 | 19.63 | 13.24 |
| Sodium bicarbonate | | 0.67 | 3.00 | | | | | | |
| Photobleach particle | 0.01 | | 0.01 | 0.01 | 0.01 | 0.01 | | | |
| Lipase (11.00 mg active/g) | 0.70 | | 0.70 | 0.70 | 0.70 | 0.70 | | 0.70 | 0.70 |
| Amylase (21.55 mg active/g) | 0.33 | | 0.33 | 0.33 | 0.33 | 0.33 | 0.63 | 0.33 | 0.33 |
| Protease (56.00 mg active/g) | 0.43 | | 0.43 | 0.43 | 0.43 | 0.43 | 0.36 | 0.33 | |
| Protease (32.89 mg active/g) | | | | | | | | | 0.54 |
| Cellulase (2.3 mg active/g) | | | | | | | 0.15 | | 0.18 |
| Tetraacetyl ethylene diamine agglomerate (92 wt % active) | 4.35 | | 4.35 | 4.35 | 4.35 | 4.35 | 2.59 | 6.50 | 2.43 |
| Suds suppressor agglomerate (11.5 wt % active) | 0.87 | 0.50 | 0.87 | 0.87 | 0.87 | 0.87 | 2.50 | 2.60 | |
| Suds suppressor agglomerate (12.6 wt % active) | | | | | | | | | 1.98 |
| Acrylate/maleate copolymer particle (95.7 wt % active) | 0.29 | | 0.29 | 0.29 | 0.29 | 0.29 | | | |
| Green/blue carbonate speckle | 0.50 | | 0.50 | 0.50 | 0.50 | 0.50 | | 2.50 | |
| Blue carbonate speckle | | | | | | | 2.00 | | |
| Blue phosphate speckle | | | | | | | 2.69 | | |
| Sodium sulphate | 3.32 | | 0.32 | 2.64 | 3.32 | 0.00 | 27.53 | 1.98 | 4.40 |
| Perfume | 0.63 | 0.75 | 0.63 | 0.63 | 0.63 | 0.63 | 0.44 | | 0.33 |
| Total amount | 100.00 | 100.00 | 100.00 | 100.00 | 100.00 | 100.00 | 100.00 | 100.00 | 100.00 |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. The solid detergent composition comprising a C₁-C₃ alkyl carbonate salt.

2. The composition according to claim 1, wherein the C₁-C₃ alkyl carbonate salt is a methyl carbonate salt.

3. The composition according to any claim 1, wherein the C₁-C₃ alkyl carbonate salt is in particulate form having a weight average mean particle size of from 100 micrometers to 800 micrometers, and wherein no more than 10 wt % of the C₁-C₃ alkyl carbonate salt has a particle size greater than 1150 micrometers and wherein no more than 10 wt % of the C₁-C₃ alkyl carbonate salt has a particle size less than 50 micrometers.

4. The composition according to claim 3, wherein the composition comprises from 0.1 wt % to 20 wt % C₁-C₃ alkyl carbonate salt.

5. The composition according to claim 4, wherein the composition further comprises a detergent adjunct component, and wherein the C₁-C₃ alkyl carbonate salt is in the form of a co-particulate admix with the detergent adjunct component.

6. The composition according to claim 5, wherein the detergent adjunct component comprises a bleach activator.

7. The composition according to claim 6, wherein the bleach activator comprises tetraacetyl ethylene diamine.

8. The composition according to claim 5, wherein the detergent adjunct component further comprises an acid source.

9. The composition according to claim 8, wherein the acid source comprises sulphamic acid and/or citric acid.

10. The composition according to claim 5, wherein the detergent adjunct component further comprises tetraacetyl ethylene diamine and an acid source.

11. The composition according to claim 5, wherein the detergent adjunct component further comprises a detersive surfactant.

12. The composition according to claim 5, wherein the detergent adjunct component further comprises an alkyl polyglucoside.

13. The composition according to claim 12, wherein the composition further comprises an anionic detersive surfactant.

14. The composition according to claim 13, wherein the composition further comprises a non-ionic detersive surfactant and a cationic detersive surfactant.

15. The composition according to claim 5, wherein the composition comprises less than 5 wt % zeolite builder and less than 5 wt % phosphate builder.

16. The composition according to claim 5, wherein the composition is essentially free from zeolite builder.

17. The composition according to claim 16, wherein the composition is essentially free from phosphate builder.

18. The composition according to claim 5, wherein the composition further comprises sulphamic acid or a water-soluble salt thereof.

19. The composition according to claim 5, wherein the composition further comprises citric acid or a water-soluble salt thereof.

20. The composition according to claim 5, wherein the composition is in free-flowing particulate form.
